(19) United States
(12) Patent Application Publication
(10) Pub. No.: US 2024/0392702 A1
(43) Pub. Date: Nov. 28, 2024

(54) DOWNHOLE HEAT EXCHANGER FOR GEOTHERMAL POWER SYSTEMS

(71) Applicant: Sage Geosystems Inc., Bellaire, TX (US)

(72) Inventors: Lev M. RING, Bellaire, TX (US); Douglas SIMPKINS, Bellaire, TX (US); Robert Lance COOK, Bellaire, TX (US)

(21) Appl. No.: 18/694,323

(22) PCT Filed: Sep. 26, 2022
(86) PCT No.: PCT/US2022/044736

§ 371 Date: Mar. 21, 2024

Related U.S. Application Data
(63) Continuation-in-part of application No. PCT/US22/36552, filed on Jul. 8, 2022.
(60) Provisional application No. 63/248,965, filed on Sep. 27, 2021.

(51) Int. Cl. F01K 27/02; F01K 25/10; F24T 10/30; F28D 21/00

(52) U.S. Cl. CPC F01K 27/02; F01K 25/10; F24T 10/30; F28D 21/00

(57) ABSTRACT

A geothermal power system includes a power generation unit and at least one production well coupled to the power generation unit. The at least one production well is positioned at least partially within a geothermal reservoir. The production well includes at least one wellbore with a wellbore wall. A first tubing is positioned within the at least one wellbore and defines a first annular flow path through the first tubing. A second tubing is positioned around the first tubing and defines a second annular flow path between the first tubing and the second tubing. A third annular flow path is between the second tubing and the wellbore wall. A production fluid may flow in the same direction as a working fluid through the production well. The working fluid is used to generate electricity with the power generation unit. The working fluid may be a liquid, gas, or supercritical fluid.

### REFERENCE TO EARLIER FILED APPLICATIONS

The present application is an International Patent Application under the Patent Cooperation Treaty and claims priority to and the benefit of U.S. Provisional Patent Application Ser. No. 63/248,965 filed Sep. 27, 2022 and titled Downhole Heat Exchanger for Geothermal Power Systems, the disclosure of which is incorporated in its entirety by this reference and International Patent Cooperation Treaty Application PCT/US2022/036552 filed Jul. 8, 2022 and titled Thermally Insulated Tubing for Geothermal Power Systems, the disclosure of which are incorporated in their entirety by these references.

### BACKGROUND

The present application relates to downhole heat exchangers for use in geothermal power systems and, more specifically, the arrangement of downhole pipe and the direction of flow of fluids in those pipes to form a downhole heat exchanger.

Geothermal energy is a type of renewable energy generated within the earth. While it may be used directly for heating, it can also be transformed into electricity, typically through the use of surface turbines. Geothermal power produces relatively little carbon dioxide or other pollutants that contribute to global climate change and may reduce the reliance upon fossil fuels.

Historically, geothermal energy and production has centered around areas of the Earth with higher-than-normal temperature rocks are found relatively nearer to the surface. The regional nature of these resources limits the potential growth of geothermal power.

Further, the efficiency of geothermal power systems is directly a function of the amount of heat that can be transferred from below the Earth's surface—typically via a carrier medium, such as water and/or other fluids—and the change of temperature that carrier medium undergoes at the surface.

The efficiency of present geothermal systems typically is less than 10 percent. In other words, less than 10 percent of the available energy is usefully converted into electricity.

The cost of producing geothermal power, then, could be significantly reduced and the ability to use medium to low temperature geothermal sources could be made available, if the efficiency of the entire geothermal power system is improved.

### BRIEF SUMMARY

A geothermal power system includes a power generation unit. At least one production well is coupled to the power generation unit. The at least one production well is positioned at least partially within a geothermal reservoir. The at least one production well includes at least one wellbore with a wellbore wall: a first tubing positioned within the at least one wellbore, the first tubing including a first tubing wall, the first tubing defining a first annular flow path through the first tubing: a second tubing positioned around the first tubing, the second tubing including a second tubing wall, the second tubing defining a second annular flow path between the first tubing wall and the second tubing wall; and, a third annular flow path between the second tubing wall and the wellbore wall. Optionally, the at least one of the first tubing and the second tubing comprises a plurality of tubing.

Optionally, the at least one production well is configured to inject a working fluid and produce a production fluid. The working fluid may be a supercritical fluid, which in turn may be at least one of carbon dioxide and ammonia. The production fluid may be at least one of brine.

The at least one production well further may include at least one casing and/or liner string (casing string and liner string may be used synonymously as any tubing that separates a wellbore wall from a flow path) with a casing wall. The at least one casing string may be positioned between the wellbore wall and the second tubing, wherein the third annular flow path is between the second tubing wall and the casing wall.

A portion of at least one of the first tubing and the second tubing may include insulated pipe. Optionally, the insulated pipe comprises vacuum insulated pipe.

The first tubing may include a first tubing thermal conductivity and the second tubing may include a second tubing thermal conductivity that is less than the first tubing thermal conductivity.

The production well may further include at least one layer of cement adjacent the wellbore wall. The at least one layer of cement may comprise an upper portion of cement with a first thermal conductivity and a lower portion of cement with a second thermal conductivity that is higher than the first thermal conductivity. The at least one layer of cement may comprise an upper portion of cement with a first thickness and a lower portion of cement with a second thickness that is smaller than the first thickness.

The first annular flow path may be configured to flow a production fluid in a first direction and the second annular flow path may be configured to flow a working fluid in the first direction. The second annular flow path may be configured to flow a working fluid in a first direction and the third annular flow path may be configured to flow the working fluid in a second direction that is opposite the first direction. The first annular flow path may be configured to flow a production fluid in a first direction and the second annular flow path may be configured to flow a working fluid in a second direction opposite the first direction. The second annular flow path may be configured to flow a working fluid in a first direction and the third annular flow path may be configured to flow a production fluid in the first direction. One of the a) first annular flow path and b) the third annular flow path may form a closed loop with the second annular flow path. The closed loop may be configured to flow a working fluid.

A method of heating a working fluid in a geothermal reservoir to produce electricity with a geothermal power system may include injecting a working fluid into the at least one production well as described above, heating the working fluid in the at least one production well; and, using the working fluid to generate electricity with the power generation unit.

The method of may further include producing a production fluid from the geothermal reservoir: flowing the production fluid in a first direction in the first annular flow path; and, flowing the working fluid in the first direction in the second annular flow path.

The method of may further include flowing the production fluid in a first direction in the second annular flow path; and, flowing the working fluid in a second direction opposite the first direction in the third annular flow path.

The method of may further include producing a production fluid from the geothermal reservoir: flowing the production fluid in a first direction in the first annular flow path; and, flowing the working fluid in a second direction opposite the first direction in the second annular flow path.

The method of may further include producing a production fluid from the geothermal reservoir: flowing the production fluid in a first direction in the third annular flow path; and, flowing the working fluid in the first direction in the second annular flow path.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Various embodiments of the present inventions are set forth in the attached figures and in the Detailed Description as provided herein and as embodied by the claims. It should be understood, however, that this Summary does not contain all of the aspects and embodiments of the one or more present inventions, is not meant to be limiting or restrictive in any manner, and that the invention(s) as disclosed herein is/are and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

To further clarify the above and other advantages and features of the one or more present inventions, reference to specific embodiments thereof are illustrated in the appended drawings. The drawings depict only typical embodiments and are therefore not to be considered limiting. One or more embodiments will be described and explained with additional specificity and detail through the use of the accompanying drawings in which:

FIG. 1 is a geothermal power system coupled to an embodiment of a downhole heat exchanger.

FIG. 2 is a cutaway perspective view of a portion of an embodiment of vacuum insulated tubing suitable for use in the downhole heat exchanger.

FIGS. 3A and 3B are a cross-section view of an embodiment of the tubing.

FIG. 4 is a cross-section view of a section of an embodiment of a concurrent flow downhole heat exchanger.

FIG. 5 is a cross-section view of a section of an embodiment of a countercurrent flow downhole heat exchanger.

FIG. 6 is a cross-section view of a section of another embodiment of a concurrent flow downhole heat exchanger.

FIG. 7A is a graph of pressure-volume data for a model of the concurrent heat exchanger of FIG. 4 with supercritical carbon dioxide (CO₂).

FIG. 7B is a graph of temperature-entropy data for the model of the concurrent heat exchanger of FIG. 4 with supercritical CO₂.

FIG. 8A is a graph of temperature-depth data for the model of the concurrent heat exchanger of FIG. 4 with supercritical CO₂.

FIG. 8B is a graph of pressure-depth data for the model of the concurrent heat exchanger of FIG. 4 with supercritical CO₂.

FIG. 8C is a graph of frictional gradient-depth data for the model of the concurrent heat exchanger of FIG. 4 with supercritical CO₂.

FIG. 8D is a graph of density-depth data for the model of the concurrent heat exchanger of FIG. 4 with supercritical CO₂.

FIG. 8E is a graph of velocity-depth data for the model of the concurrent heat exchanger of FIG. 4 with supercritical CO₂.

Common element numbers represent common features, even if the appearance of a feature varies slightly between the figures.

The drawings are not necessarily to scale.

### DETAILED DESCRIPTION

The present invention will now be further described. In the following passages, different aspects of the embodiments of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

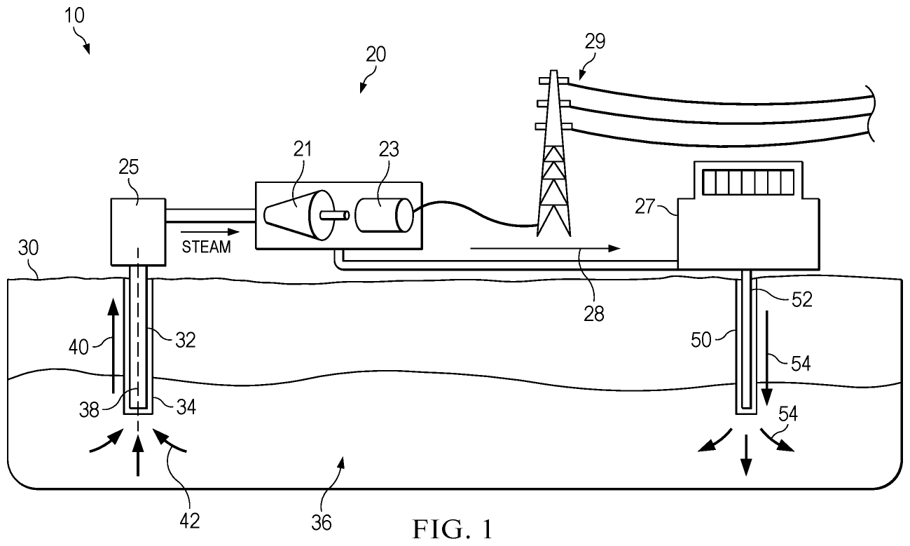

An idealized geothermal power system 10 includes a power generation unit 20 located on the Earth's surface 30 as illustrated in FIG. 1. The power generation unit 20 may be of any type that converts heat to electricity and may include any one or more of a turbine 21, generator 23, expansion unit 25, cooling unit 27 to receive the relatively cooler steam and/or water 28 from the turbine 21, and electricity transmission system 29. Some examples of representative power generation units include direct dry steam plants, flash plants, binary plants, combined-cycle or hybrid plants, and so forth, that receive heated fluid from surface or subsurface sources of heat.

The geothermal power system 10 also includes at least one tubing 32 that is configured to be positioned within a wellbore 34, the wellbore 34, in turn, being positioned in a subterranean geothermal source 36 or reservoir to return heated water or other heated working fluid 40 (including gases, liquids, and supercritical fluids such as supercritical carbon dioxide) that is heated via direct or indirect contact with any rock and/or fluid 42 in the geothermal source 36. Additionally, or alternatively, the at least one in tubing 32 may be positioned within or along a source of heat on the surface. The at least one tubing is hydraulically coupled to the power generation unit 20. The at least one tubing includes a longitudinal axis 38.

The geothermal power system 10 optionally includes an injection well 50 and optionally at least one injection tubing 52 to inject cooled water or other working fluid (for example, supercritical carbon dioxide) 54 into the geothermal source 36.

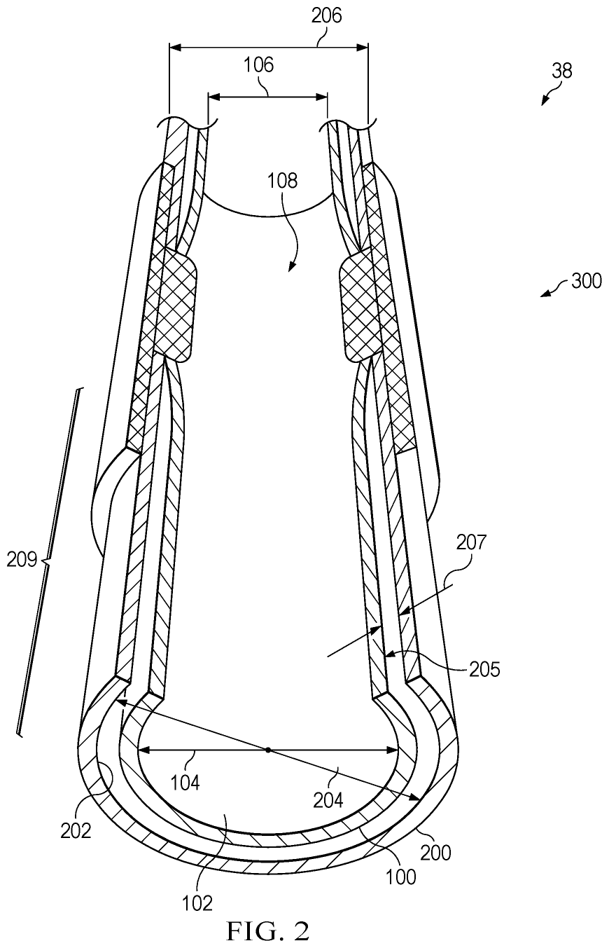

The at least one tubing 32, in turn, includes at least a first pipe 100 and at least a second pipe 200 surrounding the at least a first pipe 100 as illustrated in cutaway view in FIG. 2.

The at least a first pipe 100 includes a first annular wall 102 that defines a first inner diameter 104 and a first outer diameter 106. The first pipe 100 is configured to transport fluids within the first pipe annulus 108 defined be first annular wall 102. The first pipe 100 includes a first thermal conductivity as commonly understood, namely the rate at which heat passes through the first annular wall 102.

Optionally, the first pipe 100 is expandable to increase at least one of the first inner diameter 104 and/or the first outer diameter 106 as will be discussed below.

The at least a second pipe 200 at least partially surrounds the at least a first pipe in FIG. 2. The second pipe includes a second annular wall 202 that defines a second inner diameter 204 that is larger than the first outer diameter 106 of the at least a first pipe 100. The distance between the first outer diameter 106 and the second inner diameter 204 defines a trans-pipe annulus 205. The trans-pipe annulus 205 has a trans-pipe distance 207. The trans-pipe annulus 205 optionally holds a vacuum along at least a portion 209 of a length of the at least one tubing 32. The at least a portion 209 may optionally be any subset of or the entire length of the at least one tubing 32. The second annular wall 202 also defines a second outer diameter 206 of the second pipe 200. The second pipe 200 has a second thermal conductivity that may be the same or different than the first thermal conductivity.

The first pipe 100 and the second pipe 200 may be formed of any typical material used for pipes, including metals (steel in all its alloys, nickel, non-magnetic metals), composites, fiberglass, carbon fiber, plastics, and the like.

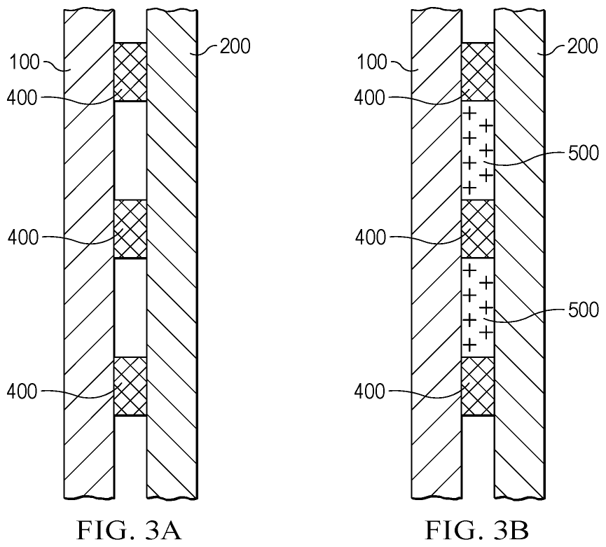

The first annular wall 102 optionally is in at least partial contact with the second annular wall 202 along a portion of the first outer diameter 106 and the second inner diameter 202, respectively, although the first outer diameter 106 could be completely separate from or completely in contact with the second inner diameter 202 with only a coating 500 (FIG. 3B) separating the first outer diameter 106 and the second inner diameter 202.

Optionally, the first pipe 100 and the second pipe 200 include a connection 300 at one or both of the uphole and the downhole end of the pipe. The connection(s) 300 allow for the first pipe 100 to be connected to another first pipe 100 or the second pipe 200 to be connected to another second pipe 200. The connection 300 may be welded, as illustrated in FIG. 2, bolted, or otherwise connected, or it may be a threaded connection, such as a threaded API connection. For example, an uphole connection (not illustrated) may be a box or female threaded connection and a downhole connection (not illustrated) may be a pin or male connection or vice-versa. For example, a downhole pin or male connection (not illustrated) of the second pipe 200 may be threaded or connected or coupled to the box or female connection of an adjacent or another second pipe 200 that is positioned downhole of the second pipe 200.

Optionally, the outer diameter 106 of at least one first pipe 100 is radially proximate to the pipe connection.

The at least one tubing 32 includes a coating 500 (FIG. 3B) applied to at least a portion of at least one of the first outer diameter 106 of the at least a first pipe 100 and the second inner diameter 204 of the at least a second pipe 200. In other words, the coating 500 may be applied to just one or both of the first inner diameter 106 and the second inner diameter 204. The coating has a thermal conductivity that is less than at least one of the first thermal conductivity and the second thermal conductivity.

Optionally, a coefficient of thermal expansion of the coating 500 is proximate a coefficient of thermal expansion of at least one of the at least one first pipe 100, the at least one second pipe 200, and the centralizer 400 (discussed below). In this case, “proximate” is defined as being a coefficient of thermal expansion for the coating 500 that is +/−20% of the coefficient of thermal expansion of at least one of the at least one first pipe 100, the at least one second pipe 200, and the centralizer 400, and more preferably +/−10%, and more preferably still +/−5%.

Optionally, the coating 500 is chemically inert with respect to water, brine, hydrocarbons, carbon dioxide, ammonia, and the like.

Optionally, the coating 500 may be a mixture of multiple components and/or the coating 500 may include at least one layer and potentially a plurality of layers with each layer comprising the same or different materials, mixtures, and components.

The coating 500 optionally includes at least one ceramic material, ceramic particles, and/or combination of ceramic particles. The ceramic particles may be composed of at least one or more of the following in all of their chemical compounds or variations: (a) yttria-stabilized zirconia (YSZ), (b) alumina and silica (as a non-limiting example, mullite or 3Al₂O₃-2SiO₂), including alumina-silicate cenospheres (a hollow sphere filled with air and/or inert gas) and alumina-silicate cenospheres made from fly ash, (c) alumina (s a non-limiting example, α-phase Al₂O₃), (d) ceria (s a non-limiting example, CeO₂), (e) ceria and yttria-stabilized zirconia, (f) rare-earth oxides (s a non-limiting example, single and mixed phase materials comprising rare earth oxides, such as La₂O₃, Nb₂O₅, Pr₂O₃, CeO₂ as main phases, (g) rare-earth zirconates (s a non-limiting example, La₂Zr₂O₇, also referred to as LZ), and (h) metal-glass composites (s a non-limiting example, a powdered mixture of metal and glass). The ceramic particles may be any size such that when the ceramic particles are included in the coating 500 the coating 500 remains rheologically and thermally suitable for applying and adhering to at least one of the first pipe 100 and the second pipe 200. As one example, the ceramic particles, including, optionally, the alumina-silicate cenospheres, may be of any size, including the sub-50 micron range.

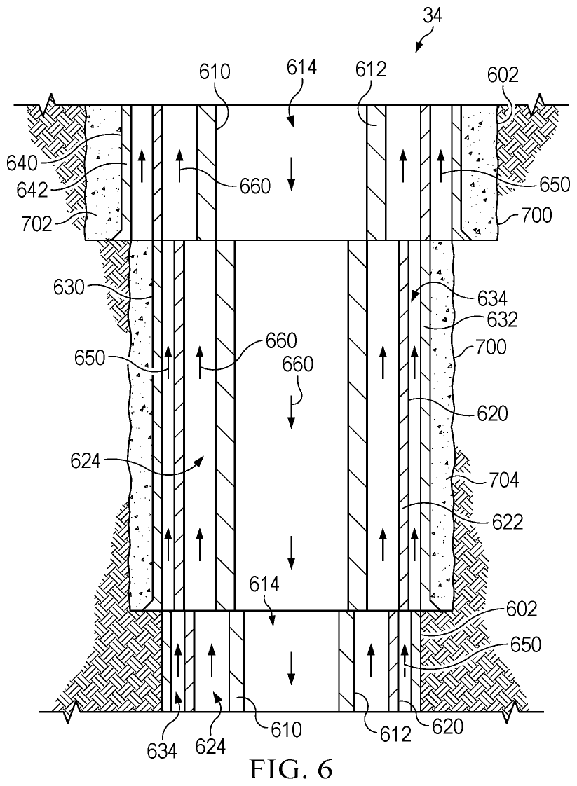

The coating 500 optionally includes a lubricant. The ceramic material and/or particles, particularly but not exclusively, the alumina-silicate cenospheres, may act as a lubricant when a mandrel 600 (FIG. 6) is drawn through a first annulus 108 of the at least a first pipe 100 to expand at least the inner diameter 104 of the at least a first pipe 100 as discussed below. The lubricant may reduce the hydraulic pressure or draw weight necessary to draw the mandrel (not illustrated) through the first annulus 108 relative to an uncoated first annulus 108 or a first annulus 108 that includes a coating 500 without a lubricant or ceramic material or ceramic particles.

The coating 500 optionally contacts the first outer diameter 106 of the at least a first pipe 100 and the second inner diameter 204 of the at least a second pipe 200 along at least a portion 209 of a length, which may be a subset or an entire length, of the at least one tubing 32. In other words, the coating 500 may span the trans-pipe distance 207 for a portion or the entire length of the tubing 32.

The coating 500 optionally includes a bond coat, such as a metallic bond coat or primer that helps the coating 500 adhere to the first pipe 100 and/or the second pipe 200. The bond coat may be an oxidation-resistant metallic layer. The bond coat may be a separate layer applied to at least the first pipe 100 and/or the second pipe 200 or it may be integral with the thermally insulative components of the coating 500. The bond coat is selected to adhere to the material of the first pipe 100 and/or the second pipe 200. The bond coat may be composed of at least one or more of the following in all of their chemical compounds or variations: an aluminum (Al), nickel (Ni), chromium (Cr), cobalt (Co), yttrium (Y), and/or platinum (Pt) alloys, such as NiCrAlY, NiCoCrAlY alloys, and other Ni and Pt aluminides.

The coating 500 also may optionally include a thermally-grown oxide (TGO) layer. The TGO layer typically is between the bond coat and the coating itself. The TGO layer may be formed of aluminum oxide (Al₂O₃). The TGO layer may be a separate layer applied or it may be integral with the thermally insulative components of the coating 500 and/or the bond coat.

At least one centralizer 400 may optionally be positioned about at least one of (a) the first outer diameter 106 of the at least a first pipe 100, (b) the coating 500, and (c) the second inner diameter 204 of the at least a second pipe 200, as illustrated in FIGS. 3A, and 3B. (Not illustrated are optional centralizers that may be positioned about the second outer diameter 206 of the second pipe 200 that may at least partially or wholly span a distance between the second outer diameter 206 and the wellbore 34.) In some instances, the at least one centralizer 400 spans the trans-pipe annulus 205 between at least one of (a) the first outer diameter 106 of the at least a first pipe 100 and the coating 500, (b) the coating 500 and the second inner diameter 204 of the at least a second pipe 200, and (c) the first outer diameter 106 of the at least a first pipe 100 and the second inner diameter 204 of the at least a second pipe 200.

The centralizer 400 may be formed of any typical material, including metals (steel in all its alloys, nickel, non-magnetic metals), composites, fiberglass, carbon fiber, plastics, and the like.

The centralizer 400 may be formed of a low thermal conductivity material. In other words, the centralizer 400 may have a third thermal conductivity that may be less than one or more of the first thermal conductivity, the second thermal conductivity, and the thermal conductivity of the coating 500. The at least one centralizer 400 may be a plurality of centralizers, wherein each centralizer is spaced apart from an adjacent centralizer along the longitudinal axis 38 of the at least one tubing 32. The spacing of the one or more centralizers may be selected to ensure the at least first pipe 100 and the at least second pipe 200 satisfy any collapse or crush requirements for a depth and hydraulic pressure anticipated to be incurred by the tubing 32. The space between adjacent centralizers may be hold at least one of a vacuum, air, inert gas, or the coating 500.

Optionally, the geothermal system comprises a plurality of tubing made up of a plurality of the tubing components described above.

Methods of manufacturing the at least one tubing 32 include one or more of the following steps in any order.

A first pipe 100 and a second pipe 200 with the attributes described above are obtained.

The method also includes applying a coating 500 to at least a portion of at least one of the first outer diameter 106 of the at least a first pipe 100 and the second inner diameter 204 of the at least a second pipe 200. The coating 500 has a coating thermal conductivity that is less than at least one of the first thermal conductivity and the second thermal conductivity.

The method also includes positioning the at least a first pipe 100 within the at least a second pipe 200 such that the at least a second pipe 200 at least partially surrounds the at least a first pipe 100 and such that the first outer diameter 106 of the at least a first pipe 100 and the second inner diameter 204 of the at least a second pipe 200 defines a trans-pipe annulus 205 with a trans-pipe distance 207.

A plurality of tubing 32 may be coupled or connected together via the connections 300 described above and coupled to the power generation unit 20. The connecting or coupling of the each of the plurality of tubing 32 together optionally occurs at the surface or in the wellbore or a combination of the two.

The method also may include applying the coating 500 with one or more of the following processes: (a) electron beam physical vapor deposition, (b) air plasma spray, (c) high-velocity oxygen fuel, (d) electrostatic spray-assisted vapor deposition, and (e) direct vapor deposition.

The method also may include positioning at least one centralizer 400 about at least one of (a) the first outer diameter 106 of the at least a first pipe 100, (b) the coating 500, and (c) the second inner diameter 204 of the at least a second pipe 200.

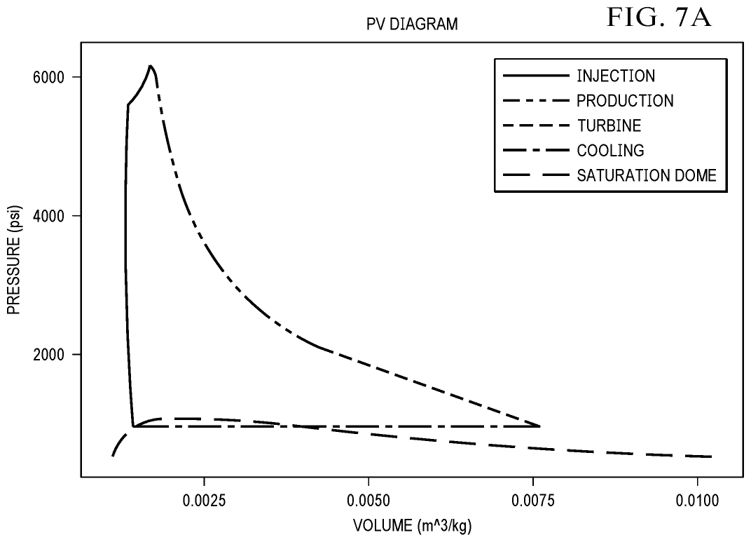

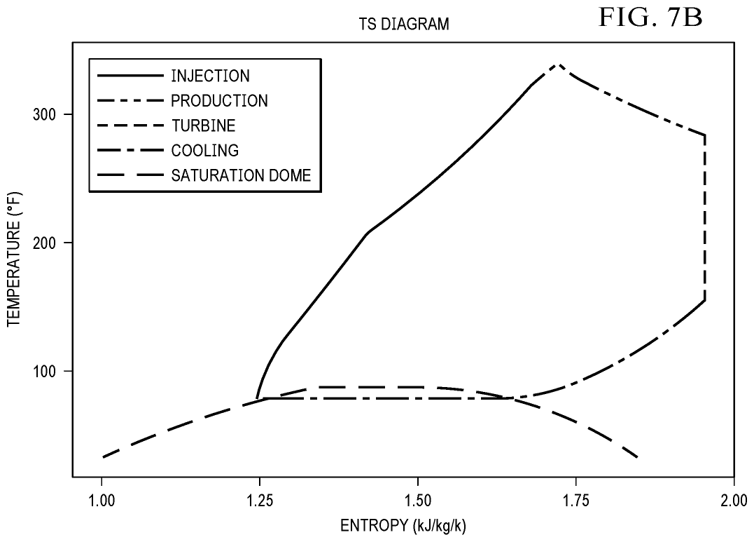

Optionally, the method includes expanding at least one of the first inner diameter 104 and the first outer diameter 106 of the at least a first pipe 100. The expanding step typically occurs after the first pipe 100 is positioned within the at least a second pipe 200, although the expanding step could occur before the first pipe 100 is positioned within the second pipe 200. The method of expanding optionally includes at least one of (a) drawing a mandrel (not illustrated) through a first pipe annulus 108 of the at least a first pipe as illustrated in FIG. 6 and (b) applying a hydrostatic force to the first inner diameter 104 of the at least a first pipe 100 as illustrated in FIG. 7 and as disclosed in U.S. Pat. No. 8,567,515, the disclosure of which is incorporated in full by this reference. An anticipated advantage of applying coatings of the type and characteristics disclosed above is that the coating likely will maintain its integrity as the at least first pipe is expanded. Stated differently, a coating applied to a component that changes in shape-such as its diameter or other dimension-typically will crack, flake, delaminate, detach from the component, in whole or in part, or otherwise suffer a failure of structural integrity. The coatings described will maintain its structural integrity—i.e., by applied area of the coating to at least one of the first outer pipe diameter and the second inner diameter, less than 20% of the total area, and, more preferably, less than 10% of the total area, and yet more preferably, less than 5% of the total area will suffer from at least one of cracking, flaking, delaminating, detaching, and/or other structural failure when the at least first pipe is expanded.

The method may further include positioning the at least one tubing 32 or a plurality of tubing in a wellbore 34 and coupling the at least one tubing 32 to the power generation unit 20.

The above discussed aspects of the vacuum insulated tubing may be used in whole or in part in any combination for the tubing that comprises the downhole heat exchangers as now described. More specifically, the downhole heat exchanger, as described, is one or more tubes or tubings designed to transfer cold fluid directly injected into the geothermal reservoir and to transfer that now hot fluid to the surface to a power generation unit: transport hot in-situ fluid in the geothermal reservoir to the surface to a power generation unit: or to expose a working fluid transported proximate to the geothermal reservoir but mechanically isolated from the geothermal reservoir, to transfer heat from the geothermal reservoir to the working fluid, and to return the working fluid to the surface to a power generation unit.

The geothermal power system 10 includes at least one production well or wellbore 34 positioned in a subterranean geothermal source or reservoir 36. Additionally, or alternatively, the at least one production wellbore 34 may be positioned within or along a source of heat on the surface. The at least one production wellbore may be hydraulically coupled to the power generation unit 20.

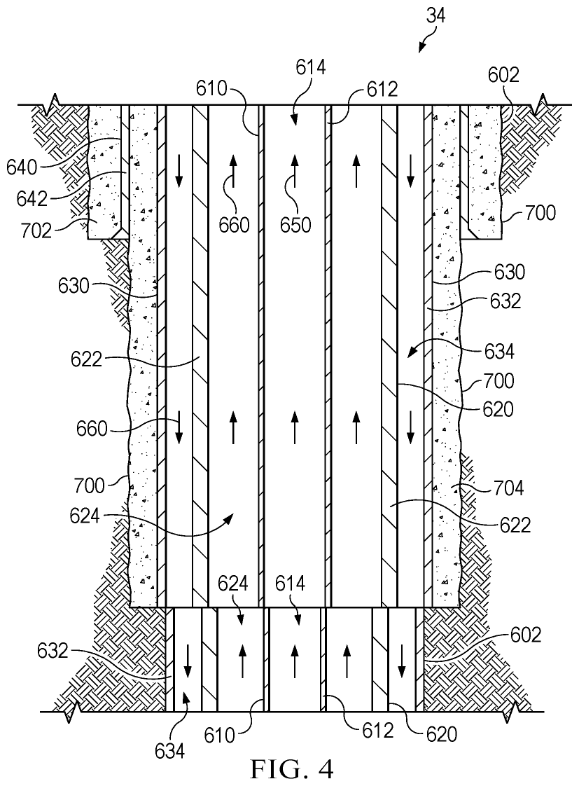

The production well includes at least one wellbore 34 with a wellbore wall 602 as illustrated in FIGS. 4-6, although a plurality of production wells may be used. The plurality of production wells may be separate wells or it may be multilateral or sidetrack wells from the main production wellbore 34.

The production wellbore 34 also includes a first tubing 610 positioned within the at least one wellbore 34. The first tubing includes a first tubing wall 612. The first tubing defines a first annular flow path 614 through the first tubing 610. To be clear, the expression “first tubing” encompasses one or more contiguous or adjacent tubing providing that the first annular flow path 614 is fluidly contiguous as illustrated in FIGS. 4-6. Stated differently, the first tubing 610 may including one or more sections of open hole, casing, liner, and/or production tubing. This definition of “tubing” applies the same to the second tubing, third tubing, and so forth discussed below.

A second tubing 620 is positioned around the first tubing 610, the second tubing 620 including a second tubing wall 622. The second tubing 620 defines a second annular flow path 624 between the first tubing wall 612 and the second tubing wall 622.

Optionally, at least one of the first tubing 610 and the second tubing 620 comprises a plurality of tubing.

Optionally, a portion of at least one of the first tubing 610 and the second tubing 620 comprises insulated pipe as discussed above with respect to tubing 100 and or 200. In some instances, the insulated pipe may comprise vacuum insulated pipe.

Optionally, the first tubing 610 includes a first tubing thermal conductivity and the second tubing 620 includes a second tubing thermal conductivity that is less than the first tubing thermal conductivity. The differences in the thermal conductivity of the first tubing 610 and the second tubing 620 may be a function of different materials used in the first tubing 610) and the second tubing 620, the presence or lack thereof of insulated coatings, differences in the thickness of the walls of the first tubing 610 and the second tubing 620, and the like.

A third annular flow path 634 is between the second tubing wall 622 and the wellbore wall 602 and/or a third tubing 630 with a third tubing wall 632 and/or cement 700 or other zonal isolation compound (discussed below).

The production wellbore 34 may include at least one or more casing and/or liner strings 640 with a casing wall 642. In some instances (not illustrated), the third tubing 630 is not used and the casing string/liner 640 may be positioned between the wellbore wall 602 and the second tubing 620, in which case the third annular flow path 634 is between the second tubing wall 622 and the casing wall 642.

The production wellbore 34 optionally includes at least one layer of cement 700 or other zonal isolation compound adjacent the wellbore wall 602 and one or more of the casing 640, third tubing 630, second tubing 620, and first tubing 610. The at least one layer of cement 700 may include an upper portion 702 of cement 700 with a first thermal conductivity and a lower portion 704 of cement 700 with a second thermal conductivity that is higher than the first thermal conductivity. Additionally or alternatively, the at least one layer of cement 700 may include an upper portion 702 of cement with a first thickness and a lower portion 704 of cement with a second thickness that is smaller than the first thickness. Additionally or alternatively, the at least one layer of cement 700 may include an upper portion 702 of cement 700 with a first density and a lower portion 704 of cement 700 with a second density that is less than the first density. The differences in the thermal conductivity of the upper portion 702 and the lower portion 704 of the cement 700 may be a function of different materials used in the different portions of the cement 700, the presence or lack thereof of insulated coatings, differences in the thickness of the walls of the cement 700 in the upper portion 702 and the lower portion 704, and the like. For example, the upper portion 702 may use a type of cement 700 typically used in Arctic drilling that limits or prevents permafrost through which the cemented well passes from thawing. Other examples including using additives such as alumina silicate beds or high water-saturated cements. The thermal conductivity of the cement 700 in the upper portion 702 may be less than 1.0 Watts per meter-Kelvin (W/mK), less than 0.6 W/mK, less than 0.3 W/mK, or any range between 0 and 1.0 W/mK. The thermal conductivity of the cement 700 in the lower portion 704 may range between 1.0 to 10 W/mK, 1.0 to 6 W/mK, 4.0 to 6.0 W/mK, 1.0 to 3.0 W/mK, or any ranges inclusive of and between these ranges.

The production wellbore 34 is configured to inject a working fluid and produce a production fluid. Optionally, the production well may be configured to flow the production fluid and the working fluid in any way desired.

For example, and as illustrated in FIG. 4, the first annular flow path 614 may be configured to flow a production fluid 650 in a first direction and the second annular flow path 624 is configured to flow a working fluid 660 in the first direction as indicated by the arrows pointing upward.

An advantage of the configuration in FIG. 4 in which the working fluid 660 flows in the second direction in the third annular flow path 634—downhole in this instance—proximate the casing 640 and the cement 700 is that the working fluid 660 from the surface is relatively cool. The relatively cooler working fluid 660 in the third annular flow path 634 may help cool the casing 640 or help maintain the casing 640 at a relatively cooler temperature than would otherwise occur if relatively hotter working fluid 660 or production fluid 650 were to flow from downhole to uphole in the third annular flow path 634. This relatively cooler working fluid 660 may reduce and/or minimize the change in the temperature of the casing 640 and/or the cement 700, i.e., thermal cycling, and to minimize the potential thermal cycling damage done to the casing 640 and/or the cement 700. In addition, the relatively cooler working fluid 660 flowing downhole in the third annular flow path 634 may reduce and/or minimize the potential expansion in size of the wellhead (i.e., the injector and surface equipment through which the various annular flow paths are introduced to and removed from the wellbore) that may be caused by the lengthening of an uncemented portion of the casing 640 during thermal expansion. The configuration in FIG. 4 in which the relatively cooler working fluid 660 is introduced into the third annular flow path 634 to flow downhole also may reduce or mitigate pressure buildup which may, in rare circumstances, cause the casing 640 to collapse as sometimes occurs in conventional hot well casing designs during production operations.

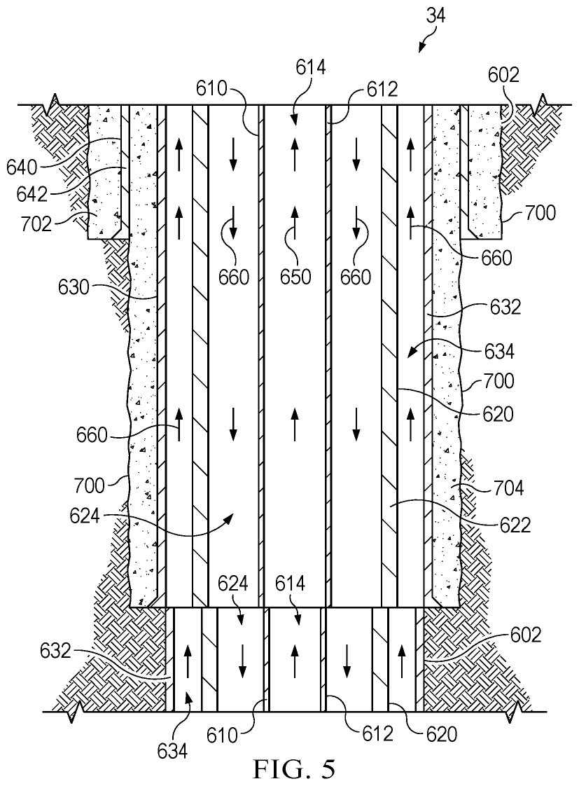

As another example as illustrated in FIGS. 4 and 5, the second annular flow path 624 may be configured to flow a working fluid 660 in a first direction and the third annular flow path 634 is configured to flow the working fluid 660 in a second direction that is opposite the first direction as illustrated by the arrows.

As another example as illustrated in FIG. 5, the first annular flow path 614 may be configured to flow a production fluid 650 in a first direction and the second annular flow path 624 is configured to flow a working fluid 660 in a second direction opposite the first direction as illustrated by the arrows.

As another example as illustrated in FIG. 6, the second annular flow path 624 may be configured to flow a working fluid 660 in a first direction and the third annular flow path 634 is configured to flow a production fluid 660 in the same first direction as indicated by the arrows.

One of skill in the art would appreciate that other flow configurations may be used and fall within the scope of this application.

While each of the flow paths may be open, i.e., exposed to the geothermal wellbore 34 and wellbore wall 602, two or more of the flow paths may be coupled together to form a closed loop (not illustrated). More specifically, one of a) the first annular flow path 614 and b) the third annular flow path 634 may form a closed loop with the second annular flow path 624. In other words, the first annular flow path 614 and the second annular flow path 624 may form a closed loop in that the same fluid is present in both the first annular flow path 614 and the second annular flow path 624, although the conditions/parameters (temperature, pressure, phase, etc.) of the fluid may be different in the first annular flow path 614 and the second annular flow path 624 or different along different portions of the first annular flow path 614 and the second annular flow path 624. Alternatively, the third annular flow path 634 and the second annular flow path 624 may form a closed loop in that the same fluid is present in both the third annular flow path 634 and the second annular flow path 624, although the conditions/parameters (temperature, pressure, phase, etc.) of the fluid may be different in the third annular flow path 634 and the second annular flow path 624 or different along different portions of the third annular flow path 634 and the second annular flow path 624. The working fluid 660 typically flows through the closed loop with the remaining flow path not in the closed loop typically being used to flow production fluid 650 from the geothermal reservoir 36.

The working fluid 660 may be any type of fluid, including fresh water, brine (typically greater than 2 parts per thousand of dissolved salt, typically sodium and chloride, but other salts are included in this definition), ammonia, benzene, other hydrocarbons, organic compounds, other liquids, other gases, and the like. Fluid is defined to include both liquids, gases, and supercritical fluids. A supercritical fluid is any substance at a temperature and pressure above its critical point where distinct liquid and gas phases do not exist, but below the pressure at which the substance becomes a solid. Optionally, the working fluid 660 may be supercritical water, supercritical carbon dioxide, supercritical ammonia, and so forth.

The production fluid 650 may include water, brine (typically greater than 2 parts per thousand of dissolved salt, typically sodium and chloride, but other salts are included in this definition), hydrocarbons, organic compounds, other liquids, other gases, and the like present in the geothermal reservoir 36.

Methods of heating a working fluid 660 in a geothermal reservoir 36 to produce electricity with a geothermal power system 10 are disclosed. The method includes injecting a working fluid 660 into the at least one production well 34. The production well 34 may include any or all of the features described above and in any combination. The method further includes heating the working fluid 660 in the at least one production well 34 and then using the working fluid 660 to generate electricity with the power generation unit 20.

The method may also include producing a production fluid 650 from the geothermal reservoir 36 and flowing the production fluid 650 in a first direction in the first annular flow path 614 as illustrated in FIG. 4. The method also may include flowing the working fluid 660 in the first direction in the second annular flow path 624.

The method may include flowing the production fluid 650 in a first direction in the second annular flow path 624 and flowing the working fluid 660 in a second direction opposite the first direction in the third annular flow path 634 as illustrated in FIGS. 4 and 5.

The method may include producing a production fluid 650 from the geothermal reservoir 36 and flowing the production fluid 650 in a first direction in the first annular flow path 614. The method may also include flowing the working fluid 660 in a second direction opposite the first direction in the second annular flow path 624 as illustrated in FIG. 5.

The method may include producing a production fluid 650 from the geothermal reservoir 36 and flowing the production fluid 650 in a first direction in the third annular flow path 634. The method may also include flowing the working fluid 660 in the first direction in the second annular flow path 624 as illustrated in FIG. 6.

Computer modeling of various configurations and flow directions of the production well 34 were completed. As is well known with thermodynamics and heat exchangers, the most efficient exchange of heat between two fluid mediums typically occurs when the cool medium flows counter or in a direction opposite to the warm medium.

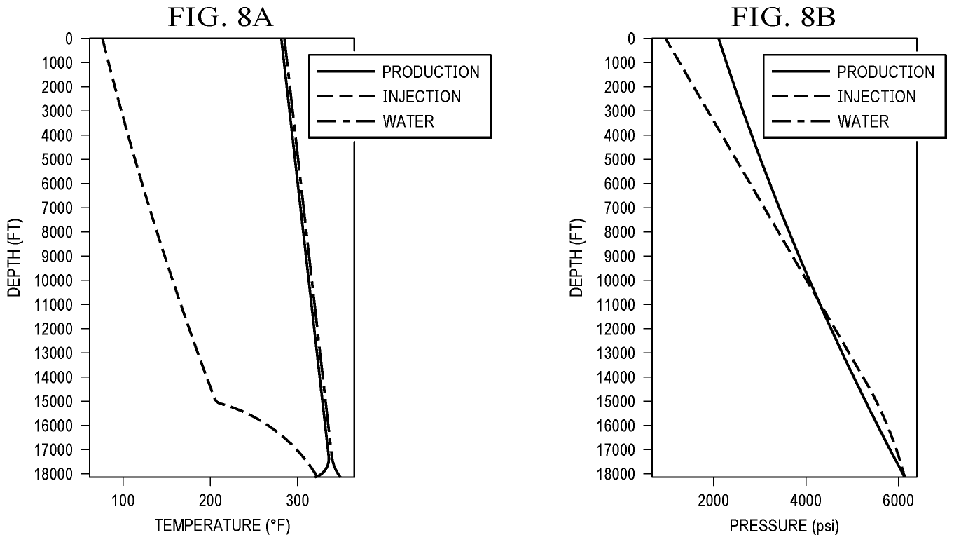

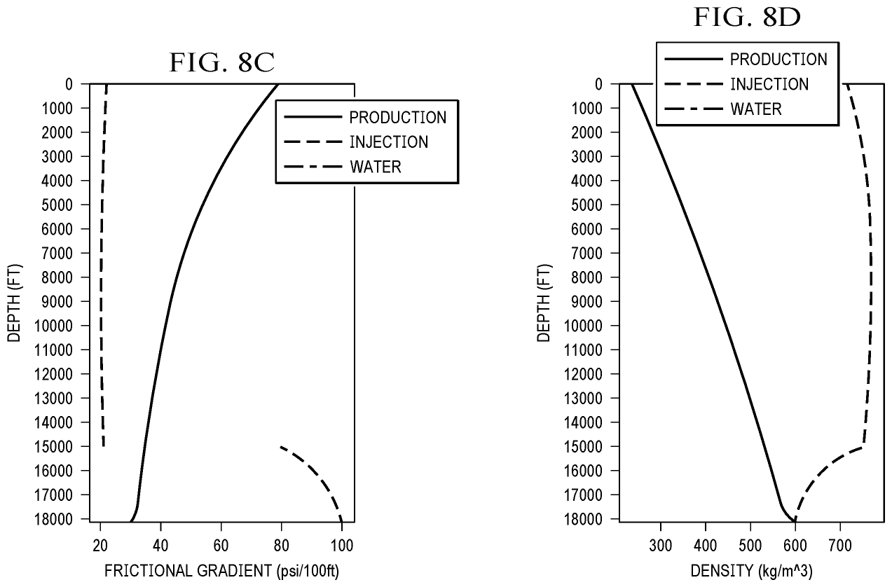

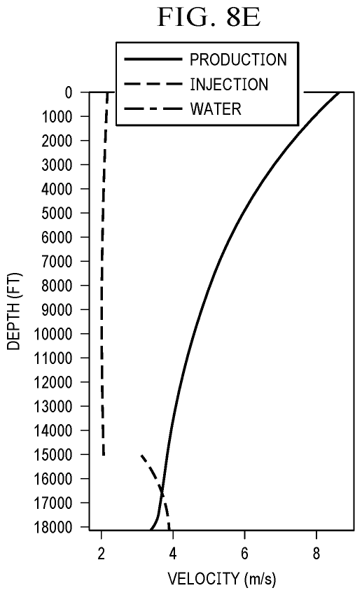

In an example illustrated at FIGS. 7A, 7B, and 8A-8E, the efficiency of the exchange of heat between a production fluid 650 and a working fluid 660 was modeled using the arrangement of flows as illustrated in FIG. 4 and FIGS. 8A-8E and using supercritical carbon dioxide (CO₂) as the working fluid 660 flowing through the second annular flow path 624 and third annular flow path 634 with water or brine produced in the geothermal reservoir 36 flowing upward through the first annular flow path 614. Stated differently, the relatively hot production fluid 650 produced from the geothermal reservoir 36 flowed in a first direction, upward, through the first annular flow path 614. The working fluid 660—supercritical carbon dioxide—also flowed in the first direction, upward, through the second annular flow path 624. The working fluid 660 in the second annular flow path 624 was heated and significantly less dense than the working fluid 660 being injected into the production well 34 through the third annular flow path 634.

Surprisingly and contradicting expectations that counter-current flow/heat exchangers are more efficient, in this concurrent flow example more heat was transferred from the production fluid 650 to the working fluid 660 than when the working fluid 660 was flowing in the same direction as the production fluid 650 in a counter-flow direction (FIG. 5).

FIGS. 7A and 7B illustrate the Pressure-Volume, or PV diagram of the pressure and the volume of the supercritical CO₂ as it is injected into the geothermal reservoir 36, is heated and returned to the surface, transfers its energy to a turbine 21, and is then cooled in the cooling unit 27 of the downhole heat exchanger of FIG. 4. The pressure in pounds per square inch is plotted on the vertical axis and the volume in cubic meters per kilogram (m³/kg) is plotted on the horizontal axis. The solid injection line shows a rapid, near vertical increase in pressure with a fixed volume as the supercritical CO₂ is pumped into the geothermal reservoir. As the pressure increases with a relatively constant volume, the density of the supercritical CO₂ in the third annular flow path 634 must increase as the depth increases.

The volume increases as the supercritical CO₂ transitions from the third annular flow path 634 proximate the maximum depth into the second annular flow path 624. Because the volume of the supercritical CO₂ increases its density consequently must decrease for a given constant pressure. In other words, the density of the supercritical CO₂ is higher proximate the surface and increases as the depth increases until proximate the transition from the third annular flow path 634 to the second annular flow path 624.

The dashed production line illustrates the supercritical CO₂ as it returns to the surface or near the surface via the second annular flow path 624. The pressure decreases exponentially as the volume increases as the supercritical CO₂ flows upward towards the surface in the second annular flow path 624. (To be clear, the dashed production line represents the heated working fluid 660 in the second annular flow path 624.)

This difference in density and the hydraulic head or pressure of the column of supercritical CO₂ above the transition from the third annular flow path 634 to the second annular flow path 624 creates a density or pressure driven fluid drive that reduces or potentially eliminates the need for a pump at the surface and/or in the second annular flow path 624 or third annular flow path 634 to cause the supercritical CO₂ to flow. Reducing or eliminating the need for a pump and the energy it requires significantly improves the energy efficiency of the entire system, which in turn may make it cost-effective to use examples like this and variations thereof in relatively lower temperature geothermal reservoirs than are typically required of known geothermal power systems.

Using tubing with a low coefficient of friction, and/or applying coatings to the inner diameter of the tubing, and/or using additives to the fluid (supercritical CO₂) flowing through the tubing, that individually or in combination reduce the coefficient of friction will reduce the friction losses in the supercritical CO₂ as the supercritical CO₂ flows through the second annular flow path 624 and the third annular flow path 634, thereby improving this pressure-driven fluid drive or siphon effect and the energy efficiency of the geothermal power system as a whole.

Using relatively large diameter tubing, such as greater than 6 inches inner diameter and more preferably greater than 10 inches inner diameter, yet further reduces friction losses relative to tubing with a smaller inner diameter.

Returning to the PV diagram in FIG. 7A, the supercritical CO₂ reaches and expands in the turbine 21 as pressure further decreases, as illustrated with the dashed turbine line. The supercritical CO₂ transfers its heat energy to the turbine 21, thereby creating electricity.

Upon exiting the turbine 21, the supercritical CO₂ is cooled in any variety of manner, including the cooling unit 27, in cooling towers, heat exchanges, and the like as illustrated at the dashed cooling line, before it is reinjected into the wellbore via the third annular flow path 634.

The dashed saturation dome line represents the saturation dome of the supercritical CO₂ in the process.

FIG. 7B represents the temperature-entropy, or TS diagram, of the supercritical CO₂ working fluid 660 as it is injected into the geothermal reservoir 36, is heated and returned to the surface in FIG. 4 and transfers its energy to a turbine 21, and is then cooled in the cooling unit 27. The temperature in degrees Fahrenheit (° F.) are illustrated on the vertical axis and the entropy in kilojoules per kilogram per Kelvin (KJ/kg/K) are illustrated in the horizontal axis.

As the supercritical CO₂ is injected proximate the surface into the third annular flow path 634 as illustrated at the solid injection line, the temperature and the entropy of the supercritical CO₂ increases.

The temperature and the entropy both increase as the supercritical CO₂ transitions from the third annular flow path 634 proximate the maximum depth into the second annular flow path 624 until the temperature reaches a maximum and begins decreasing as the supercritical CO₂ flows upward through the second annular flow path 624 and the entropy continues increasing as illustrated in the dashed production line. (To be clear, the dashed production line represents the heated working fluid 660 in the second annular flow path 624.)

Upon reaching the turbine 21, the supercritical CO₂ decreases temperature significantly at a constant or nearly constant entropy as illustrated in the dashed turbine line.

Upon exiting the turbine 21, the supercritical CO₂ is cooled before being reinjected into the geothermal reservoir 36 via the third annular flow path 634, as illustrated in the dashed cooling line. The dashed saturation dome line represents the saturation dome of the supercritical CO₂ in the process.

FIGS. 8A-8E illustrate a model of various parameters of the supercritical CO₂ as it is injected through the third annular flow path 634 (dashed injection line) and returns or is produced via the second annular flow path 624 (solid production line) plotted against depth.

FIG. 8A illustrate that the temperature in degrees Fahrenheit versus depth in feet of the water or production fluid 650 produced via the first annular flow path 614 is illustrated in the dashed water line in FIG. 8A and decreases slightly as the water travels upwards towards the surface and away from the geothermal reservoir 36. The loss in temperature of the production fluid 650/produced water reflects, in part, a transfer of heat to the supercritical CO₂ in the second annular flow path 624.

The dashed injection line and the solid production line (almost obscured by and nearly coincident with the dashed water line plotting the temperature of the produced water) are the temperature in degrees Fahrenheit versus depth in feet of the supercritical CO₂ in the third annular flow path 634 being injected into the geothermal reservoir 36 and the supercritical CO₂ in the second annular flow path 624 as it returns to the surface.

FIG. 8B illustrates the pressure in pounds per square inch versus depth in feet of the supercritical CO₂ in the third annular flow path 634 in the dashed injection line and in the second annular flow path 624 in the solid production line as it returns to the surface. The range of pressures illustrates that CO₂ typically remains in the supercritical flow regime.

FIG. 8C illustrates the frictional gradient in pounds per square inch per 100 feet versus depth in feet of the supercritical CO₂ in the third annular flow path 634 in the dashed injection line and in the second annular flow path 624 in the solid production line as it returns to the surface. As illustrated, there is little change in the frictional gradient versus depth in the third annular flow path 634, but a nearly 100 percent change in the frictional gradient in the second annular flow path 624 between the depth of the geothermal reservoir 36 and the surface.

FIG. 8D illustrates the density in kilograms per cubic meter versus depth in feet of the supercritical CO₂ in the third annular flow path 634 in the dashed injection line and in the second annular flow path 624 in the solid production line as it returns to the surface. As illustrated, the density of the supercritical CO₂ in the third annular flow path 634 increases slightly to a near steady state as depth increases until reaching the geothermal reservoir 36, where the density decreases modestly with depth. As the supercritical CO₂ working fluid 660 flows into the second annular flow path 624, the density steadily decreases as the supercritical CO₂ returns to the surface.

FIG. 8E illustrates the velocity in meters per second versus depth in feet of the supercritical CO₂ in the third annular flow path 634 in the dashed injection line and in the second annular flow path 624 in the solid production line as it returns to the surface. As illustrated, the velocity of the supercritical CO₂ working fluid 660 in the third annular flow path 634 is relatively constant as the supercritical CO₂ flows downward until reaching the geothermal reservoir 36. As the supercritical CO₂ flows into the second annular flow path 624, the velocity steadily increases as the supercritical CO₂ returns to the surface.

Surprisingly and contrary to expectations, the data modeling shows that the concurrent flow of the supercritical CO₂ working fluid 660 as modeled at FIG. 4, 7A-8E is more efficient than counter-current flow (FIG. 5). Supercritical CO₂, may provide a thermo-siphon effect by which the pressure/temperature/density fluid improves efficiencies by reducing or potentially eliminating the need for a pump to provide a differential pressure to the fluid. The efficiencies thus gained may be greater than any nominal loss in differential temperature capacity of the supercritical CO₂ relative to steam/water.

While the process may use a Rankine cycle of any of the various types (supercritical, organic, regenerative, or reheat), improved efficiencies may be further obtained with a Brayton cycle.

Collectively, modeling suggests that the use of supercritical CO₂ with a concurrent flow heat exchanger as described above with respect to FIG. 4 and the hypothetical examples may expand the range of geothermal reservoirs that are of lower temperature than typical geothermal reservoirs. For example, rather than requiring a geothermal reservoir with a downhole temperature of more than 175 degrees Celsius, modeling suggests that the using the system as described in FIGS. 4 and 7A-8E may allow the economical production of energy from geothermal reservoirs with much lower downhole temperatures less than 175 degrees Celsius, less than 150 degrees Celsius, and even less than 125 degrees Celsius. Even with these relatively lower reservoir temperatures, there is a sufficient temperature differential in the supercritical CO₂ across the turbine or power generation unit to economically produce energy or electricity. These results, consequently solve a long unmet need, namely economic production of energy with relatively low temperature geothermal reservoirs, which expands the number of locations in which such geothermal power systems may be used.

The following numbered examples recite various elements and features of the application and may be combined in any order and/or combination. The following numbered examples are party of the original disclosure as filed.

### Numbered Examples

1. A geothermal power system, comprising:
a power generation unit;
at least one production well coupled to the power generation unit, the at least one production well being positioned at least partially within a geothermal reservoir, the at least one production well including:
   at least one wellbore with a wellbore wall;
   a first tubing positioned within the at least one wellbore, the first tubing including a first tubing wall, the first tubing defining a first annular flow path through the first tubing;
   a second tubing positioned around the first tubing, the second tubing including a second tubing wall, the second tubing defining a second annular flow path between the first tubing wall and the second tubing wall; and,
   a third annular flow path between the second tubing wall and the wellbore wall.
      2. The geothermal power system of claim 1, wherein the at least one production well is configured to inject a working fluid and produce a production fluid.
      3. The geothermal power system of claim 1, wherein at least one of the first tubing and the second tubing comprises a plurality of tubing.
      4. The geothermal power system of claim 1, wherein the at least one production well further comprises at least one casing string with a casing wall, the at least one casing string being positioned between the wellbore wall and the second tubing, wherein the third annular flow path is between the second tubing wall and the casing wall.
      5. The geothermal power system of claim 1, wherein a portion of at least one of the first tubing and the second tubing comprises an insulated pipe.
      6. The geothermal power system of claim 5, wherein the insulated pipe comprises vacuum insulated pipe.
      7. The geothermal power system of claim 1, wherein the first tubing includes a first tubing thermal conductivity and the second tubing includes a second tubing thermal conductivity that is less than the first tubing thermal conductivity.
      8. The geothermal power system of claim 1, further comprising at least one layer of cement adjacent the wellbore wall.
      9. The geothermal power system of claim 8, wherein the at least one layer of cement comprises an upper portion of cement with a first thermal conductivity and a lower portion of cement with a second thermal conductivity that is higher than the first thermal conductivity.
      10. The geothermal power system of claim 8, wherein the at least one layer of cement comprises an upper portion of cement with a first thickness and a lower portion of cement with a second thickness that is smaller than the first thickness.
      11. The geothermal power system of claim 1, wherein the first annular flow path is configured to flow a production fluid in a first direction and the second annular flow path is configured to flow a working fluid in the first direction.
      12. The geothermal power system of claim 1, wherein the second annular flow path is configured to flow a working fluid in a first direction and the third annular flow path is configured to flow the working fluid in a second direction that is opposite the first direction.
      13. The geothermal power system of claim 1, wherein the first annular flow path is configured to flow a production fluid in a first direction and the second annular flow path is configured to flow a working fluid in a second direction opposite the first direction.
      14. The geothermal power system of claim 1, wherein the second annular flow path is configured to flow a working fluid in a first direction and the third annular flow path is configured to flow a production fluid in the first direction.
      15. The geothermal power system of claim 1, wherein one of the a) first annular flow path and b) the third annular flow path forms a closed loop with the second annular flow path.
      16. The geothermal power system of claim 15, wherein the closed loop is configured to flow a working fluid.
      17. The geothermal power system of claim 2, wherein the working fluid includes a supercritical fluid.
      18. The geothermal power system of claim 17, wherein the supercritical fluid includes at least one of carbon dioxide and ammonia.
      19. The geothermal power system of claim 2, wherein the production fluid includes at least one of brine.
      20. A method of heating a working fluid in a geothermal reservoir to produce electricity with a geothermal power system, comprising:
injecting a working fluid into the at least one production well of claim 1;
heating the working fluid in the at least one production well; and,
using the working fluid to generate electricity with the power generation unit of claim 1.
   21. The method of claim 20, further comprising:
producing a production fluid from the geothermal reservoir;
flowing the production fluid in a first direction in the first annular flow path; and,
flowing the working fluid in the first direction in the second annular flow path.
   22. The method of claim 20, further comprising:
flowing the production fluid in a first direction in the second annular flow path; and,
flowing the working fluid in a second direction opposite the first direction in the third annular flow path.
   23. The method of claim 20, further comprising:
producing a production fluid from the geothermal reservoir;
flowing the production fluid in a first direction in the first annular flow path; and,
flowing the working fluid in a second direction opposite the first direction in the second annular flow path.
   24. The method of claim 20, further comprising:
producing a production fluid from the geothermal reservoir;
flowing the production fluid in a first direction in the third annular flow path; and,
flowing the working fluid in the first direction in the second annular flow path.

The one or more present inventions, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure.

The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A geothermal power system, comprising:
a power generation unit; and
at least one production well coupled to the power generation unit, the at least one production well being positioned at least partially within a geothermal reservoir, the at least one production well including:
at least one wellbore with a wellbore wall;
a first tubing positioned within the at least one wellbore, the first tubing including a first tubing wall, the first tubing defining a first annular flow path through the first tubing;
a second tubing positioned around the first tubing, the second tubing including a second tubing wall, the second tubing defining a second annular flow path between the first tubing wall and the second tubing wall; and
a third annular flow path between the second tubing wall and the wellbore wall.

2. The geothermal power system of claim 1, wherein the at least one production well further comprises at least one casing string with a casing wall, the at least one casing string being positioned between the wellbore wall and the second tubing, wherein the third annular flow path is between the second tubing wall and the casing wall.

3. The geothermal power system of claim 1, wherein a portion of at least one of the first tubing and the second tubing comprises an insulated pipe.

4. The geothermal power system of claim 3, wherein the insulated pipe comprises vacuum insulated pipe.

5. The geothermal power system of claim 1, wherein the first tubing includes a first tubing thermal conductivity and the second tubing includes a second tubing thermal conductivity that is less than the first tubing thermal conductivity.

6. The geothermal power system of claim 1, further comprising at least one layer of cement adjacent the wellbore wall, wherein the at least one layer of cement comprises an upper portion of cement with a first thermal conductivity and a lower portion of cement with a second thermal conductivity that is higher than the first thermal conductivity.

7. The geothermal power system of claim 1, further comprising at least one layer of cement adjacent the wellbore wall, wherein the at least one layer of cement comprises an upper portion of cement with a first thickness and a lower portion of cement with a second thickness that is smaller than the first thickness.

8. The geothermal power system of claim 1, wherein the first annular flow path is configured to flow a production fluid in a first direction and the second annular flow path is configured to flow a working fluid in the first direction.

9. The geothermal power system of claim 1, wherein the second annular flow path is configured to flow a working fluid in a first direction and the third annular flow path is configured to flow a production fluid in the first direction.

10. The geothermal power system of claim 1, wherein one of the a) first annular flow path and b) the third annular flow path forms a closed loop with the second annular flow path.

11. The geothermal power system of claim 10, wherein the closed loop is configured to flow a working fluid.

12. The geothermal power system of claim 2, wherein the at least one production well is configured to inject a working fluid, wherein the working fluid includes a supercritical fluid.

13. A method of heating a working fluid in a geothermal reservoir to produce electricity with a geothermal power system, comprising:
injecting a working fluid into the at least one production well of claim 1;
heating the working fluid in the at least one production well; and
using the working fluid to generate electricity with the power generation unit of claim 1.

14. The method of claim 13, further comprising:
producing a production fluid from the geothermal reservoir;
flowing the production fluid in a first direction in the first annular flow path; and
flowing the working fluid in the first direction in the second annular flow path.

15. The method of claim 13, further comprising:
producing a production fluid from the geothermal reservoir;
flowing the production fluid in a first direction in the third annular flow path; and
flowing the working fluid in the first direction in the second annular flow path.
